(19) United States
(12) Patent Application Publication
(10) Pub. No.: US 2013/0275854 A1
(43) Pub. Date: Oct. 17, 2013

(54) Segmenting a Web Page into Coherent Functional Blocks

(71) Applicants: Suk Hwan Lim, Mountain View, CA (US); Jian-Ming Jin, Beijing (CN); Li-Wei Zheng, Beijing (CN); Eamonn O'Brien-Strain, San Francisco, CA (US); Jian Fan, San Jose, CA (US)

(72) Inventors: Suk Hwan Lim, Mountain View, CA (US); Jian-Ming Jin, Beijing (CN); Li-Wei Zheng, Beijing (CN); Eamonn O'Brien-Strain, San Francisco, CA (US); Jian Fan, San Jose, CA (US)

(21) Appl. No.: 13/635,410

(22) PCT Filed: Apr. 19, 2010
(86) PCT No.: PCT/CN2010/000523

§ 371 Date: Sep. 15, 2012

(51) Int. Cl. G06F 17/22

(52) U.S. Cl. CPC G06F 17/2247
USPC 715/234

(57) ABSTRACT

Segmenting a web page (110) into coherent function blocks (705-1 to 705-8) includes parsing content from the web page (110) into multiple coherent, collectively exhaustive nodes (405-1 to 405-37); calculating at least one matrix (500, 600, 605-1 to 605-4) of affinity values between each of the nodes (405-1 to 405-37); and clustering the nodes (405-1 to 405-37) into functional blocks (705-1 to 705-8) based on the affinity values in the at least one matrix (500, 600, 605-1 to 605-4).

### BACKGROUND

Web pages provide an inexpensive and convenient way to make information available to its consumers. However, as the inclusion of multimedia content, embedded advertising, and online services becomes increasingly more prevalent in modem web pages, the web pages themselves have become substantially more complex. For example, in addition to their main content, many web pages display auxiliary content such as background imagery, advertisements, or navigation menus, and links to additional content.

It is often the case that owners or consumers of web pages wish to utilize or adapt only a portion of the information presented in a web page. For instance, a user may desire to print a physical copy of an internet article without reproducing any of the irrelevant content on the web page containing the article. Similarly, an owner of a web page may wish to adapt a web page into another document, such as a marketing brochure, without including content in the web page that is superfluous to the new document. Such uses of only a portion of the content presented in a web page can require tedious effort on the part of a user to distinguish among the different types of content on the web page and retrieve only the desired content.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram of an illustrative system for segmenting a web page into coherent functional blocks according to one exemplary embodiment of principles described herein.

FIG. 2 is a block diagram of an illustrative functionality implemented by an illustrative computerized web page segmentation device, according to one exemplary embodiment of principles described herein.

FIG. 3 is a diagram of an illustrative internet browser rendering a web page capable of division into coherent functional blocks, according to one exemplary embodiment of principles described herein.

FIG. 4 is a diagram of an illustrative division of the web page of FIG. 3 into coherent, collectively exhaustive nodes, according to one exemplary embodiment of principles described herein.

FIG. 5 is a diagram of an illustrative affinity matrix for nodes of a web page, according to one exemplary embodiment of principles described herein.

FIG. 6 is a diagram of an illustrative composite affinity matrix for nodes of a web page, according to one exemplary embodiment of principles described herein.

FIG. 7 is a diagram of an illustrative segmentation of the web page of FIG. 3 into functional blocks, according to one exemplary embodiment of principles described herein.

FIG. 8 is a flowchart diagram of an illustrative method of segmenting a web page into coherent functional blocks, according to one exemplary embodiment of principles described herein.

Throughout the drawings, identical reference numbers designate similar, but not necessarily identical, elements.

### DETAILED DESCRIPTION

The present specification discloses various methods, systems, and devices for segmenting a web page into coherent functional blocks. The methods, systems, and devices disclosed in the present specification accomplish this goal by parsing the web page into a plurality of coherent and collectively exhaustive nodes, calculating at least one matrix of affinity values between the separate nodes; and clustering the nodes into functional areas based on the at least one matrix of affinity values.

The web page segmentation process described herein segments a web page into a number of meaningful function or logical blocks. These functional blocks can be advantageously used to, for example, extract only the content from a web page that is useful to a specific application. In additional or alternative examples, the functional blocks may be advantageously used to preserve the visual continuity of content when reformatting or applying a new layout to the web page.

As used in the present specification and in the appended claims, the term “web page” refers to a document that can be retrieved from a server over a network connection and viewed in a web browser application.

As used in the present specification and in the appended claims, the term “node” refers to one of a plurality of coherent units into which the entire content of a web page has been partitioned.

As used in the present specification and in the appended claims, the term “collectively exhaustive,” as applied to a node, refers to the property wherein all such nodes for a particular web page comprise in their sum the totality of content displayed on that web page.

As used in the present specification and in the appended claims, the term “coherent,” as applied to a node, refers to the characteristic of having content only of the same type or property.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative systems, devices, and methods for semantically ranking content in a web page.

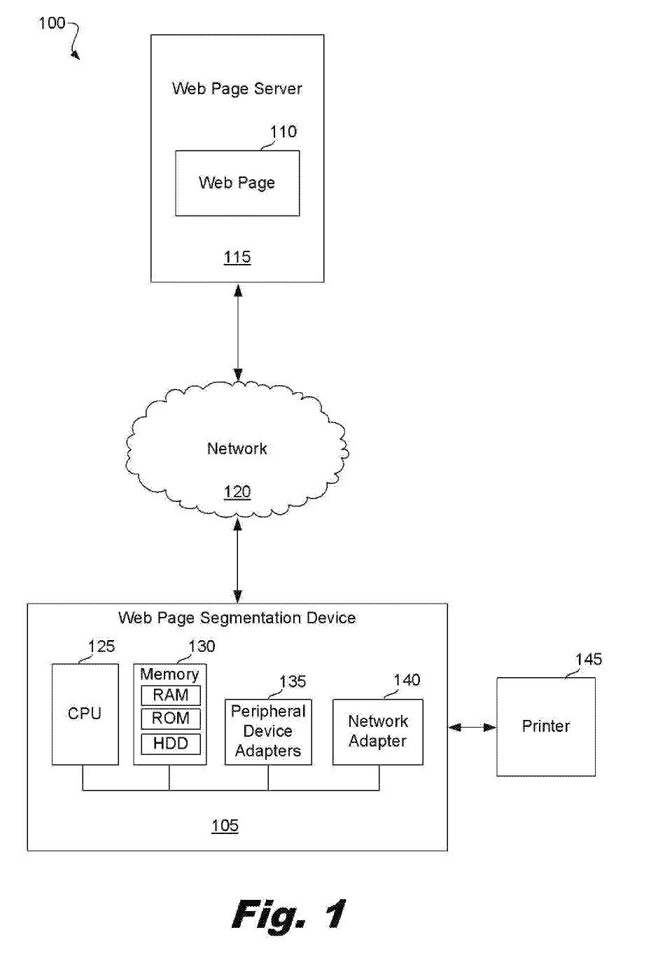

Referring now to FIG. 1, an illustrative system (100) for segmenting a web page into coherent functional blocks includes a web page segmentation device (105) that has access to a web page (110) stored by a web page server (115). In the present example, for the purposes of simplicity in illustration, the web page segmentation device (105) and the web page server (115) are separate computing devices communicatively coupled to each other through a mutual connection to a network (120). However, the principles set forth in the present specification extend equally to any alternative configuration in which a web page segmentation device (105) has complete access to a web page (110). As such, alternative embodiments within the scope of the principles of the present specification include, but are not limited to, embodiments in which the web page segmentation device (105) and the web page server (115) are implemented by the same computing device, embodiments in which the functionality of the web page segmentation device (105) is implemented by a multiple interconnected computers (e.g., a server in a data center and a user's client machine), embodiments in which the web page segmentation device (105) and the web page server (115) communicate directly through a bus without intermediary network devices, and embodiments in which the web page segmentation device (105) has a stored local copy of the web page (110) to be segmented.

The web page segmentation device (105) of the present example is a computing device configured to retrieve the web page (110) hosted by the web page server (115) and divide the web page (110) into multiple coherent, functional blocks. In the present example, this is accomplished by the web page segmentation device (105) requesting the web page (110) from the web page server (115) over the network (120) using the appropriate network protocol (e.g., Internet Protocol (“IP”)). Illustrative processes of segmenting the web page content will be set forth in more detail below.

To achieve its desired functionality, the web page segmentation device (105) includes various hardware components. Among these hardware components may be at least one processing unit (125), at least one memory unit (130), peripheral device adapters (135), and a network adapter (140). These hardware components may be interconnected through the use of one or more busses and/or network connections.

The processing unit (125) may include the hardware architecture necessary to retrieve executable code from the memory unit (130) and execute the executable cede. The executable code may, when executed by the processing unit (125), cause the processing unit (125) to implement at least the functionality of retrieving the web page (110) and semantically segmenting the web page (110) into coherent functional blocks according to the methods of the present specification described below. In the course of executing code, the processing unit (125) may receive input from and provide output to one or more of the remaining hardware units.

The memory unit (130) may be configured to digitally store data consumed and produced by the processing unit (125). The memory unit (130) may include various types of memory modules, including volatile and nonvolatile memory. For example, the memory unit (130) of the present example includes Random Access Memory (RAM), Read Only Memory (ROM), and Hard Disk Drive (HDD) memory. Many other types of memory are available in the art, and the present specification contemplates the use of any type(s) of memory (130) in the memory unit (130) as may suit a particular application of the principles described herein. In certain examples, different types of memory in the memory unit (130) may be used for different data storage needs. For example, in certain embodiments the processing unit (125) may boot from ROM, maintain nonvolatile storage in the HDD memory, and execute program code stored in RAM.

The hardware adapters (135, 140) in the web page segmentation device (105) are configured to enable the processing unit (125) to interface with various other hardware elements, external and internal to the web page segmentation device (105). For example, peripheral device adapters (135) may provide an interface to input/output devices to create a user interface and/or access external sources of memory storage. Peripheral device adapters (135) may also create an interface between the processing unit (125) and a printer (145) or other media output device. For example, in embodiments where the web page segmentation device (105) is configured to generate a document based on functional blocks extracted from the web page's content, the web page segmentation device (105) may be further configured to instruct the printer (145) to create one or more physical copies of the document.

A network adapter (140) may provide an interlace to the network (120), thereby enabling the transmission of data to and receipt of data from other devices on the network (120), including the web page server (115).

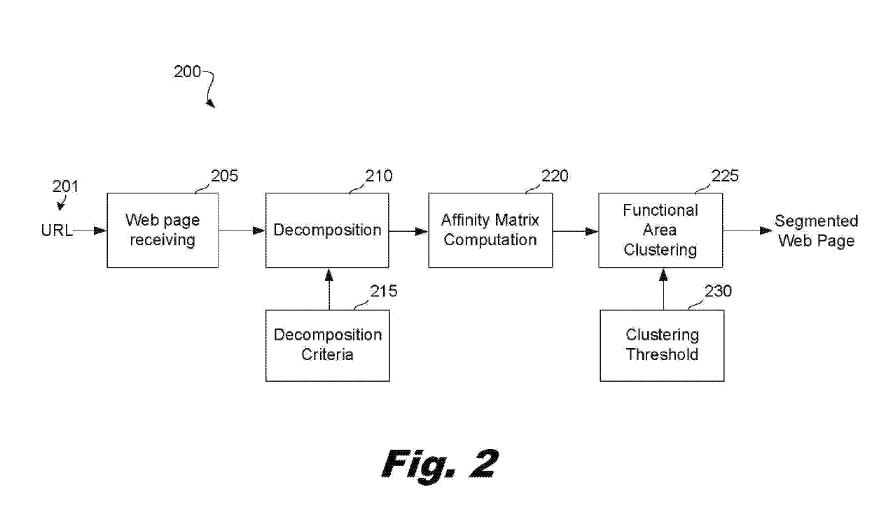

Referring now to FIG. 2, a block diagram is shown of an illustrative functionality (200) implemented by a web page segmentation device (105, FIG. 1) consistent with the principles described herein. Each module in the diagram represents an element of functionality performed by the processing unit (125) of the web page segmentation device (105, FIG. 1). Arrows between the modules represent the communication and interoperability among the modules.

In the example of FIG. 2, the wed segmentation device (105, FIG. 1) is configured to take a bottoms-up approach to web page segmentation by casting the problem of segmentation into a clustering problem. By way of overview, the device (105, FIG. 1) is configured to segment the web page into functional blocks by first dividing the web page into basic nodes, compute various affinities or distances between the nodes to form at least one affinity matrix, and cluster the nodes into functional areas or blocks using the elements in the at least one affinity matrix.

In the present example, a URL (201) for a web page is received by a web page receiving module (205). For example, the web page receiving module (205) may perform the functions of fetching the web page from its server and rendering the web page to determine a layout of the content in the web page. The URL (201) may be specified by a user of the web page segmentation device (105, FIG. 1) or, alternatively, be determined automatically. The web page receiving module (205) may then request the web page from its server over a network such as the internet using the URL. The web page received in response to the request is then made available to a decomposition module (210), which partitions the web page content into multiple basic content nodes, or “atoms.”

Certain properties are desirable for the nodes resulting from the decomposition of the web page. The nodes should be atomic; in other words, the nodes should never have to be broken up into smaller pieces. The nodes should also be collectively exhaustive such that all nodes collectively contain all of the content visible in the web page. It is also very desirable that each node be coherent (i.e., contains content of the same property) and mutually exclusive (i.e., no two nodes contain the same content).

Many methods of decomposing web page content into nodes having the above properties are available or pending development. Any suitable method of decomposing web page content into such nodes is commensurate with the scope of the present specification. Decomposition criteria (215) may be provided to the decomposition module (210) to effect a desired method of web page decomposition.

One such method of decomposing a web page into nodes having the above properties is through the analysis of a hierarchical tree structure in a Document Object Model (DOM) of the web page. The DOM tree structure of the web page may be inherent to or generated from the Hypertext Markup Language (HTML) or other web document from which the web page is rendered. Thus, in certain embodiments the decomposition criteria (215) provided to the decomposition module (210) may be that a node is a leaf node in the DOM tree where:
Visibity==visible
Display≠none
Z-index is the highest value for any other visible leaf nodes in the same position (i.e., the leave node is the highest layer displayed in its position)
Type is either (1) Text, (2) Image, or (3) Flash
   These decomposition criteria (215) will allow the decomposition module (210) to parse the web page into nodes that are atomic, coherent, and collectively exhaustive.

An affinity matrix computation module (220) may calculate one or more matrices in which a numeric representation of the “affinity” between any two nodes of the web page is given. As used in the present specification and in the appended claims, the “affinity” between two nodes is a measure of the probability that the two nodes are interdependent or related to the same subject matter. In certain embodiments, multiple affinity matrices may be created for the nodes, in which each affinity matrix relies on a different criterion for calculating node affinity. These matrices may then be combined into a composite affinity matrix that specifies a composite affinity value for each possible pair of nodes from the web page.

Possible criteria for calculating the affinity between two different nodes include, but are not limited to, a Euclidean or block distance between the two nodes in the rendered web page; a distance between the two nodes in the DOM tree; the respective hierarchical levels of the two nodes in the DOM tree; a degree of horizontal alignment between the two nodes in the rendered web page; a degree of vertical alignment between the two nodes in the rendered web page; a number of other nodes displayed between the two nodes in the rendered web page; a difference in type between the two nodes (e.g., image, text (HTML heading1, heading2, paragraph), embedded content); a degree of difference in font size of text present in the two nodes; a difference in the number of characters in text present in the two nodes; a degree difference in visual appearance (e.g., using one or more histograms of color, intensity, edge orientation, or magnitude); a difference in node size; and a degree of overlap or enclosure between the two nodes.

A functional area clustering module (225) then performs clustering on the nodes based on the one or more affinity matrices. One simple method of doing so is to derive a connectivity map between the nodes based on one or more predetermined or adaptively computed thresholds (230). In other words, if the measured affinity between two nodes is higher than a predetermined or adaptively computed threshold, the two nodes are “connected.” Groups of interconnected nodes are then clustered together to create functional blocks, thereby completing the segmentation of the web page.

It can be important to determine the appropriate clustering threshold (230) to achieve satisfactory segmentation results. In certain embodiments, the clustering threshold (230) may be based on the type of the web page and the application of the segmentation. Alternatively, a peak value of the distribution of the affinities may be chosen as the threshold (230) for each web page. The threshold may therefore adapt to the web page and be flexible on many different types of web pages.

In certain embodiments, one or more additional modules (not shown) may be present in the functionality (200) of the web page segmentation device (105, FIG. 1) to further process the segmented web page.

For example, the web page segmentation device (105, FIG. 1) may be further configured to create a document incorporating only some of the functional blocks in the segmented web page. In this way, content may be extracted from the web page and repurposed into a different web page or other type of media, such as a printed document. In certain embodiments, the web page segmentation device (105, FIG. 1) may be configured to determine which of the functional blocks in the segmented web page are most relevant to the document being created. This determination may be made, for example, by applying a semantic analysis to the content of each of the functional blocks using criteria specified for the document to be generated. For example, a keyword search may be performed on each of the functional blocks using keywords specific to the document to be generated, and a relevancy score may then be assigned to each functional block to determine which of the blocks is most relevant to the document to be generated. Then, only those functional blocks that have a relevancy score that is higher than a predetermined or adaptively computed threshold may be incorporated into a template for the document.

This process may be performed automatically in response to an automatic or user-generated trigger. Thus, in certain embodiments a user may instruct a computer to print a web page containing an article of interest by pressing a print button. The computer may segment the web page into functional blocks as described above, and then determine which of those blocks is most relevant to the article of interest using user-generated or automatically obtained keywords. The computer may then automatically generate a document incorporating only those functional blocks that are believed to be components of the article itself (e.g., as distinguished from advertisements, navigation information, background images, irrelevant embedded content, etc.) and print the document.

In other examples, the web page segmentation device (105, FIG. 1) or another device may be configured to use the functional blocks of a web page segmented according to the above methods to reformat the web page without losing continuity in the content of the web page. For example, a web page segmentation device (105, FIG. 1) may be a mobile device with an internet browser that reformats retrieved web pages to an optimal layout for the screen size of the mobile device. By segmenting the web page into coherent functional blocks and reformatting the layout such that the functional blocks remain visually intact, the mobile device can preserve the integrity of content viewed on a web page without necessarily preserving the original formatting of the web page.

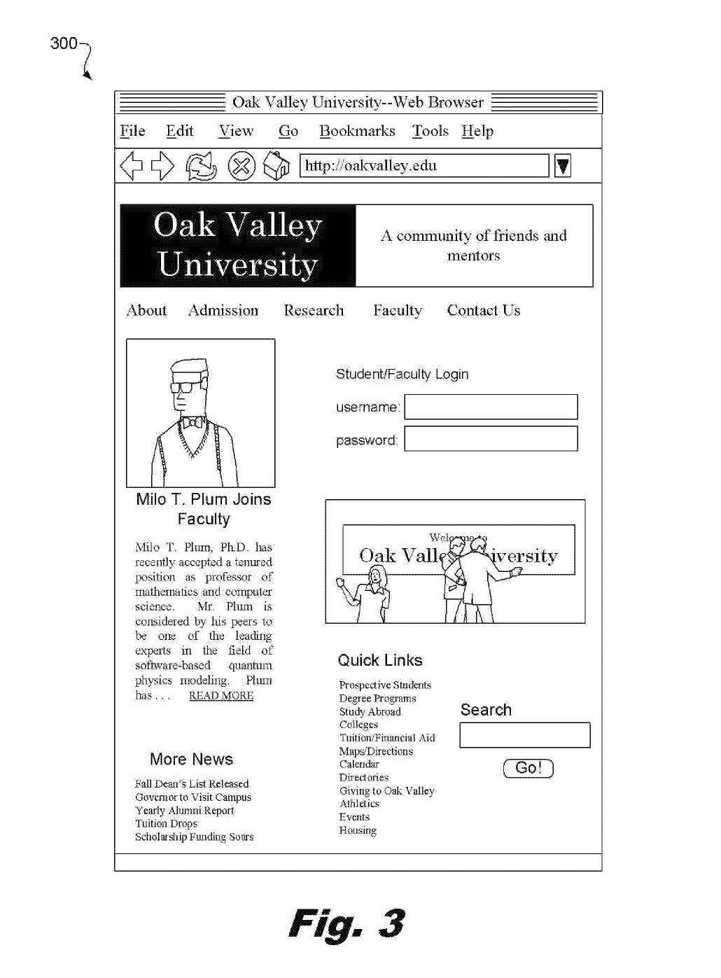

FIGS. 3-7 provide illustrations of various aspects of the process of segmenting a web page into a plurality of coherent functional blocks outlined above.

FIG. 3 is a diagram of an illustrative web browser (300) displaying a web page that can be segmented into a plurality of functional blocks consistent with the above principles.

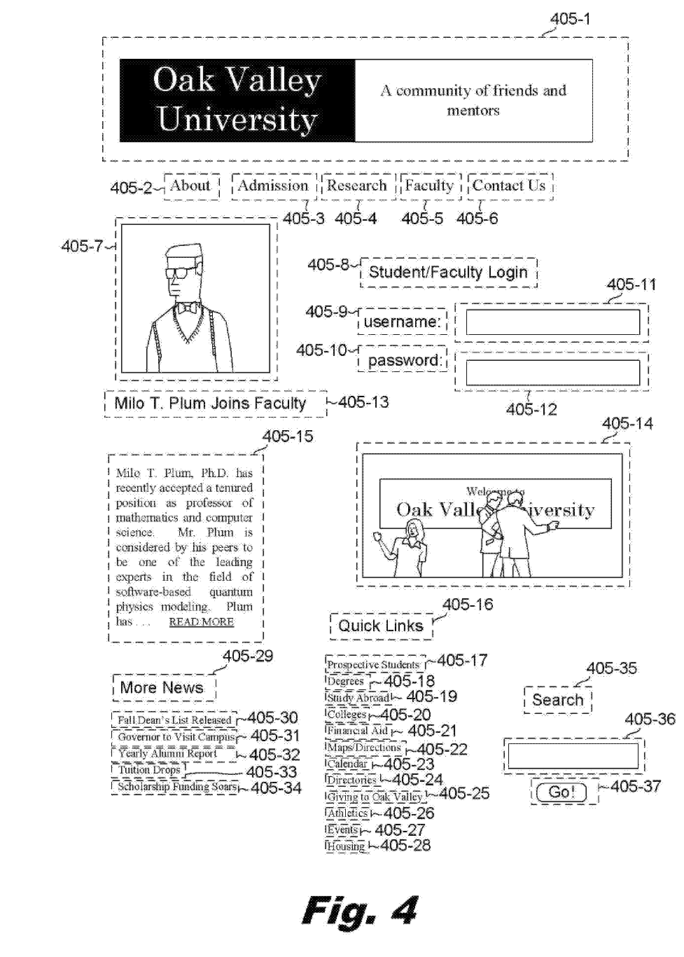

FIG. 4 is a diagram of the decomposition of the illustrative web page of FIG. 3 into a plurality of coherent nodes (403-1 to 405-37) consistent with the functionality (200) described with reference to FIG. 2. As shown In FIG. 4, these nodes (405-1 to 405-37) conform to the requirements of being atomic and coherent. Additionally, the nodes (405-1 to 405-37) are collectively exhaustive and mutually exclusive, as all of the visible content from the web page of FIG. 3 is present in the sum of the nodes (405-1 to 405-37) and no two nodes (405-1 to 405-37) share the same content.

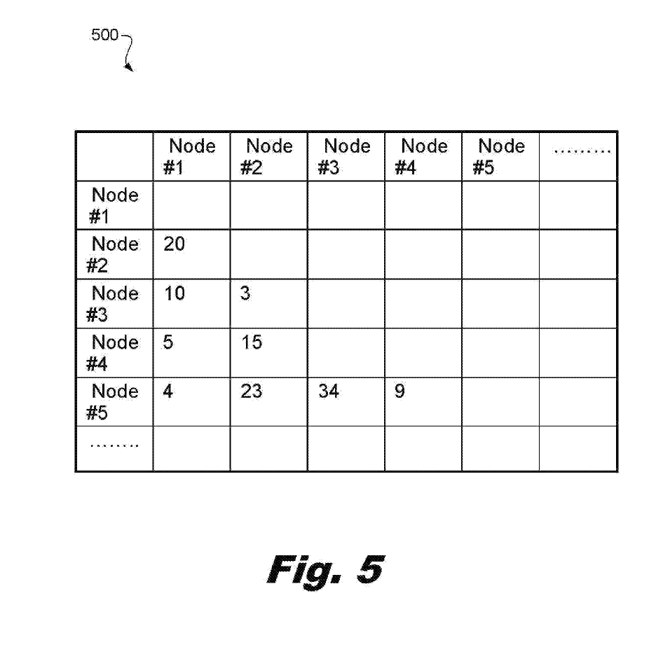

FIG. 5 is a diagram of an illustrative matrix (500) of affinity values between the nodes (405-1 to 405-37, FIG. 4) of a web page decomposed according to the functionality (200) described with reference to FIG. 2. For any two nodes (405-1 to 405-37, FIG. 4) of the web page, an affinity value may be calculated based on one or more affinity criteria, as described above.

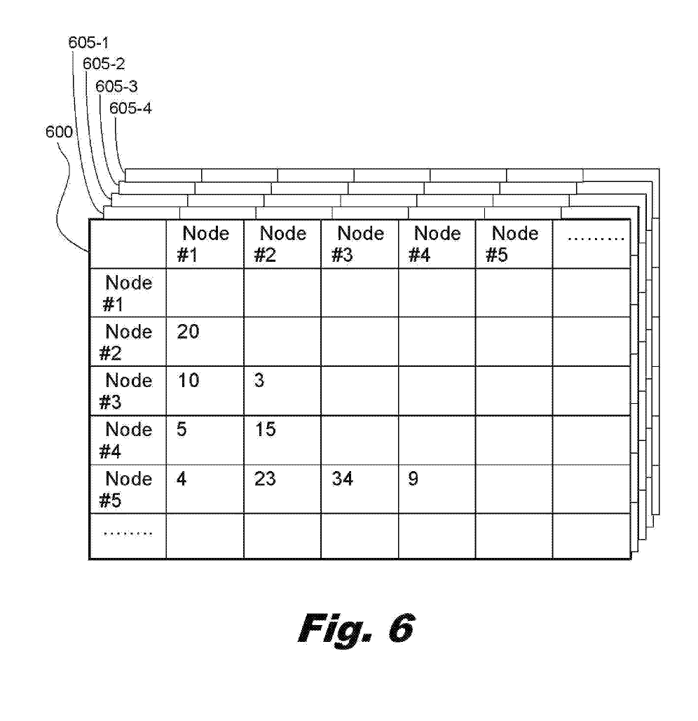

FIG. 6 is a diagram of an illustrative composite matrix (600) of affinity values between the nodes (405-1 to 405-37, FIG. 4) of a web page decomposed according to the functionality (200) described with reference to FIG. 2. As described previously, a composite matrix (600) may incorporate affinity values from multiple different primary matrices (605-1 to 605-4) to determine a composite affinity value between any two nodes (405-1 to 405-37, FIG. 4) of the web page.

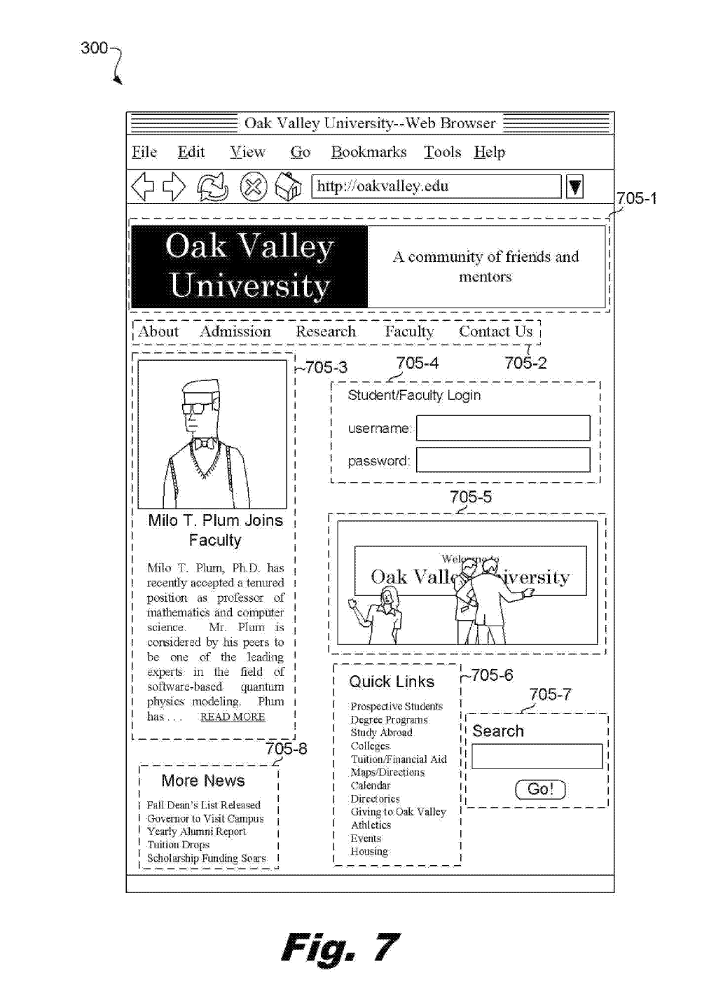

FIG. 7 is a diagram of the web page illustrated in FIG. 3 as segmented into functional blocks (705-1 to 705-8) by clustering together groups of nodes (405-1 to 405-37) wherein each node In a functional block (705-1 to 705-8) has an affinity value for each other node In that functional block (705-1 to 705-8) that is greater than a predetermined or adaptively computed threshold. These functional blocks (705-1 to 705-8) are coherent, collectively exhaustive, and mutually exclusive.

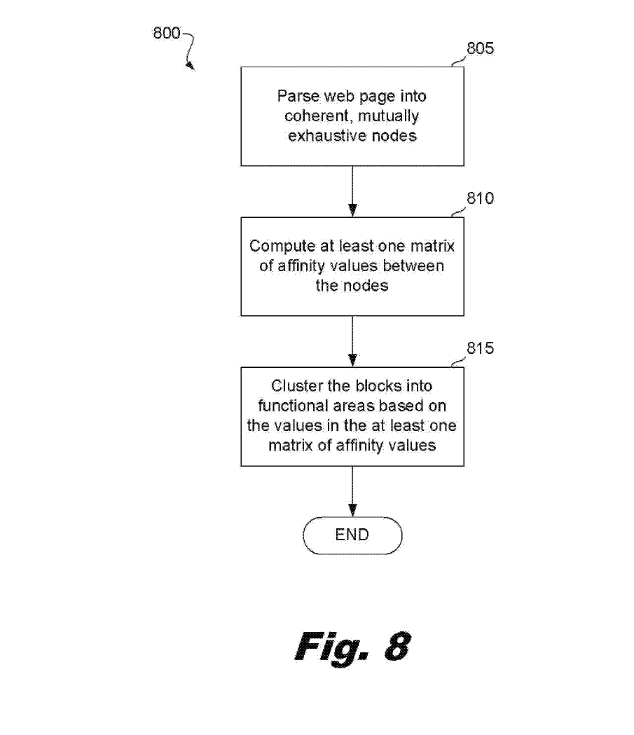

Referring now to FIG. 8, a flowchart is shown of a method (800) summarizing the process of segmenting a web page into a plurality of coherent functional blocks. This method (800) may be performed by, for example, the processing unit (125, FIG. 1) of a computerized web page segmentation device (105, FIG. 1). The method (800) includes parsing (step 805) the web page into a plurality of coherent, collectively exhaustive nodes. At least one matrix of affinity values between the nodes is computed (step 810). The affinity values may be calculated using one or more suitable affinity criteria, and in some embodiments a plurality of affinity value calculations may be condensed into a composite matrix of affinity values. The nodes are then clustered (step 815) into functional areas based on the values in the at least one matrix of affinity values. Specifically, in certain embodiments each cluster may include multiple nodes such that each node in the cluster has an affinity value for each other node in the cluster that is greater than a predefined threshold.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method performed by a physical computing system (100) comprising at least one processor (125) for segmenting a web page (110) into coherent functional blocks (705-1 to 705-8), said method comprising:
parsing content from said web page (110) into a plurality of coherent, collectively exhaustive nodes (405-1 to 405-37) with said physical computing system (100);
calculate at least one matrix (500, 600, 605-1 to 605-4) of affinity values between each of said nodes (405-1 to 405-37) with said physical computing system (100); and
clustering said nodes (405-1 to 405-37) Info functional blocks (705-1 to 705-8) based on said affinity values in said at least one matrix (500, 600, 605-1 to 605-4) with said physical computing system (100).

2. The method according to claim 1, in which said at least one matrix (500, 600, 605-1 to 605-4) of affinity values comprises a composite (600) of a plurality of matrices (605-1 to 605-4) of affinity values, each said matrix (605-1 to 605-4) of affinity values being based on a different criterion for determining affinity values between said nodes (405-1 to 405-37).

3. The method according to any of claims 1-2, in which each said node (405-1 to 405-37) In a said functional block (705-1 to 705-8) has an affinity value for each other said node (405-1 to 405-37) in said functional block (705-1 to 705-8) that is equal to or greater than at least one of a predetermined threshold and an adaptively computed threshold.

4. The method according to any of claims 1-3, in which each said node (405-1 to 405-37) corresponds to a leaf node in a Document Object Model (DOM) representation of said web page (110).

5. The method according to any of claims 1-4, in which said affinity value between any two said nodes (405-1 to 405-37) is at least partially based on a distance between content of said nodes (405-1 to 405-37) in said web page (110) when said web page (110) is rendered.

6. The method according to any of claims 1-5, in which said affinity value between any two said nodes (405-1 to 405-37) is at least partially based on a degree of alignment between said two nodes (405-1 to 405-37) when said web page (110) is rendered.

7. The method according to any of claims 1-6, in which said affinity value between any two said nodes (405-1 to 405-37) is at least partially based on whether said two nodes (405-1 to 405-37) comprise different types of content.

8. The method according to any of claims 1-8, further comprising optimizing a display of said web page (110) by reformatting said web page, in which said functional blocks (705-1 to 705-8) remain visually intact in said reformatting of said web page (110).

9. A computerized device (105) for segmenting a web page (110) into coherent functional blocks (705-1 to 705-8); said device comprising;
at least one processor (125); and
a memory (130) communicatively coupled to said at least one processor (125), said memory comprising executable code stored thereon such that said at least one processor (125) is configured to, when executing said executable code:
parse content from said web page (110) into a plurality of coherent, collectively exhaustive nodes (405-1 to 405-37);
calculate at least one matrix (500, 600, 605-1 to 605-4) of affinity values between each of said nodes (405-1 to 405-37); and
cluster said nodes (405-1 to 405-37) into functional blocks (705-1 to 705-8) based on said affinity values in said at least one matrix (500, 600, 605-1 to 605-4).

10. The computerized device (105) according to claim 9, in which said at least one matrix (500, 600, 605-1 to 605-4) of affinity values comprises a composite (600) of a plurality of matrices (605-1 to 605-4) of affinity values, each said matrix (605-1 to 605-4) of affinity values being based on a different criterion for determining affinity values between said nodes (405-1 to 405-37).

11. The computerized device (105) according to any of claims 9-10, in which each said node (405-1 to 405-37) in a said functional block (705-1 to 705-8) comprises an affinity value for each other said node (405-1 to 405-37) in said functional block (705-1 to 705-8) that is equal to or greater than at least one of a predetermined threshold and an adaptively computed threshold.

12. The computerized device (105) according to any of claims 9-11, in which said affinity value between any two said nodes (405-1 to 405-37) is at least partially based on a distance between content of said nodes (405-1 to 405-37) in said web page (110) when said web page (110) is rendered.

13. The computerized device (105) according to any of claims 9-12, in which said affinity value between any two said nodes (405-1 to 405-37) is at least partially based on a degree of alignment between said two nodes (405-1 to 405-37) when said web page (110) is rendered.

14. The computerized device (105) according to any of claims 9-13, in which said at least one processor (125) is further configured to optimize a display of said web page (110) by reformatting said web page (110), in which said functional blocks (705-1 to 705-8) remain visually intact in said reformatting of said web page (110).

15. A system (100) for optimizing a display of a web page (110) through segmentation of said web page (110) into coherent functional blocks (705-1 to 705-8); said system (100) comprising:
a processor (125); and
a memory (130) communicatively coupled to said processor (125), said memory (130) comprising executable code stored thereon such that said processor (125) is configured to, when executing said executable code:
parse content from said web page (110) into a plurality of coherent, collectively exhaustive nodes (405-1 to 405-37);
calculate at least one matrix (500, 600, 605-1 to 605-4) of affinity values between each of said nodes (405-1 to 405-37);
cluster said nodes (405-1 to 405-37) into functional blocks (705-1 to 705-8) based on said affinity values in said at least one matrix (500, 600, 605-1 to 605-4); and
reformat said web page (110) such that said functional blocks (705-1 to 705-8) remain visually intact in said reformatting of said web page (110).
